(19) United States
(12) Patent Application Publication
(10) Pub. No.: US 2026/0028528 A1
(43) Pub. Date: Jan. 29, 2026

(54) LUMINOPHORE, METHOD FOR THE PRODUCTION OF A LUMINOPHORE AND RADIATION-EMITTING COMPONENT

(71) Applicant: ams-OSRAM International GmbH, Regensburg (DE)

(72) Inventors: Frauke PHILIPP, Augsburg (DE); Juliane KECHELE, Stadtbergen (DE); Christiane STOLL, Schwabmuenchen (DE); Simon DALLMEIR, Landsberg am Lech (DE); Gina Maya ACHRAINER, Greifenberg (DE); Daniel BICHLER, Augsburg (DE); Johanna STRUBE-KNYRIM, Weil (DE); Mark VORSTHOVE, Augsburg (DE)

(21) Appl. No.: 18/998,154

(22) PCT Filed: Jul. 17, 2023
(86) PCT No.: PCT/EP2023/069774

§ 371 Date: Jan. 24, 2025

(30) Foreign Application Priority Data
Aug. 8, 2022 (DE) 102022119913.4

(51) Int. Cl. C09K 11/77

(52) U.S. Cl. CPC C09K 11/77748

(57) ABSTRACT

A luminophore has the general formula EA₂₋ₓREₓSi_{5-x-y}Al_{x+y}N_{8-y}O_{y}:A, where

0<x≤2 and 0≤y≤2, EA is an element or a combination of elements from the group of alkaline earth elements, RE is an element or a combination of elements from the group of rare earth elements, and A is an activator element. A method for the production of a luminophore and a radiation-emitting component are further disclosed.

### CROSS-REFERENCE TO RELATED APPLICATIONS

This application is a US National Stage application, filed under 35 U.S.C. § 371, of International Application PCT/EP2023/069774, filed on Jul. 17, 2023, and claims priority to German application 10 2022 119 913.4, filed on Aug. 8, 2022, the entirety of the above listed applications is incorporated herein by reference.

### FIELD

Various embodiments relate to a luminophore, a method for the production of a luminophore and a radiation-emitting component.

### SUMMARY

At least one embodiment is related to a luminophore with improved properties. At least one further embodiment relates to a method for the production of a luminophore with improved properties. At least one further embodiment relates to a radiation-emitting component with improved properties.

A luminophore is provided. According to at least one embodiment, the luminophore has the general formula EA₂₋ₓREₓSi_{5-x-y}Al_{x+y}N_{8-y}O_{y}:A, wherein 0<x≤2 and 0≤y≤2, wherein EA is an element or a combination of elements from the group of alkaline earth elements, RE is an element or a combination of elements from the group of rare earth elements, and A is an activator element.

The term “luminophore” is understood here and in the following to mean a wavelength conversion substance, i.e. a material which is set up to absorb and emit electromagnetic radiation. In particular, the luminophore absorbs electromagnetic radiation that has a different wavelength maximum than the electromagnetic radiation emitted by the luminophore. For example, the luminophore absorbs radiation with a wavelength maximum at shorter wavelengths than the emission maximum and thus emits radiation with an emission maximum shifted towards red. Pure scattering or pure absorption are not understood here as wavelength-converting.

Here and in the following, luminophores are described using molecular formulae. With the formulae given, it is possible that the luminophore contains further elements, for example in the form of contaminants, wherein these contaminants together are present in the luminophore in a proportion of at most 5 mol %, for example, at most 1 mol %, or for example, at most 0.1 mol %.

The luminophore is composed of elements that are present in the luminophore as ions, i.e. anions or cations. Here and in the following, the components of the luminophore, EA, RE, Si, Al, O, N and A, are referred to both as elements and as ions, cations or anions. For the sake of clarity, specific elements are not necessarily indicated together with their charge. In particular, EA, RE, Si, Al and A are present as cations, while O and N are present as anions.

The present luminophore can be uncharged on the outside. This means that there can be a complete charge balance between positive and negative charges on the outside of the luminophore. On the other hand, it is also possible that the luminophore formally does not have a complete charge balance to a small extent.

Alkaline earth elements comprise the chemical elements of the 2nd main group of the periodic table. Alkaline earth elements are presently generally selected from the group formed by beryllium, magnesium, calcium, strontium, barium and radium.

Rare earth elements presently include the chemical elements of the 3rd subgroup of the periodic table and the lanthanides. Rare earth elements are presently generally selected from the group formed by scandium, yttrium, lanthanum, cerium, praseodymium, neodymium, promethium, samarium, europium, gadolinium, terbium, dysprosium, holmium, erbium, thulium, ytterbium and lutetium.

In particular, the luminophore can have a crystalline, for example ceramic, host material or host lattice into which A is introduced as an activator element. The luminophore is, for example, a ceramic material.

The activator element A changes the electronic structure of the host material in such a way that electromagnetic radiation of a first wavelength range can be absorbed by the luminophore. This so-called primary radiation can excite an electronic transition in the luminophore, which can return to the ground state by emitting electromagnetic radiation of a second wavelength range, also known as secondary radiation. The activator element, which is introduced into the host material, is thus responsible for the wavelength-converting properties of the luminophore.

A luminophore described here can, for example, emit secondary radiation in the cyan to NIR (NIR: near infrared) wavelength range when excited with primary radiation from the blue or UV spectral range. Using only one class of material, i.e. one luminophore system, a wide variation of luminophores with different conversion properties can thus be obtained. In particular, the entire visible spectral range can be covered with the luminophore described here, especially if it is excited with UV to blue primary radiation. It is also possible to excite it with different primary radiation, for example with semiconductor chips emitting different radiation. The luminophore is therefore suitable for use in luminophore-converted LEDs (LED: light-emitting diode) and can be used for various applications depending on the choice of activator element A and the exact composition.

To date, only a few material systems are known in which a luminophore covers the entire wavelength range from cyan to NIR and can therefore be used for a wide variety of applications.

For example, Ba₂Si₅N₈:Ce³⁺ and Ba₂Si₅N₈:Eu²⁺ are known to date, wherein Ba₂Si₅N₈:Ce³⁺ is not used commercially and Ba₂Si₅N₈:Eu²⁺ is only available as a partially substituted variant with Sr as (Ba, Sr)₂Si₅N₈:Eu²⁺. The emission position and shape of the emission spectrum of Ba₂Si₅N₈:Ce³⁺ and Ba₂Si₅N₈:Eu²⁺ is less flexible than that of the luminophore described here and can only be varied by using further alkaline earth elements or by substitution with aluminum and oxygen, which nevertheless does not cover the entire wavelength range.

As a result, different luminophore systems have been used to date if the entire range from cyan to NIR is to be covered:

For emission in the cyan-green spectral range, Eu-activated luminophores such as Ca₈Mg(SiO₄)₄Cl₂:Eu²⁺ are conventionally used in particular, but these exhibit undesirable quenching effects even at low irradiance levels of around 100 mW/mm², leading to a reduction in quantum efficiency. For the use of Ce-doped luminophores in the cyan spectral range, mainly garnet luminophores such as Lu₃(Al, Ga)₅O₁₂:Ce³⁺ have been available to date. However, these emit mainly in the green spectral range with only a small proportion of the spectrum in the cyan range. Cyan-emitting, Ce-doped luminophores are not yet commercially available. The garnet luminophores Lu₃(Al, Ga)₅O₁₂:Ce³⁺ also show only a small overlap with the sensitivity curve of the photoreceptor melanopsin. This means that they are only slightly effective in increasing the attention and alertness of an observer in Human Centric Lighting applications and are therefore not suitable for such applications. In addition, these luminophores can only be excited in a narrow range of the blue spectrum and are therefore not suitable for use in LEDs with deep blue primary radiation or primary radiation in the near UV (NUV) range.

To date, only a few efficient luminophores are known that efficiently convert NUV to blue primary radiation into orange secondary radiation. For the red to deep red spectral range, only Eu²⁺-activated luminophores are in use, e.g. the systems (Ca, Sr, Ba)₂Si₅N₈:Eu²⁺ and (Ca, Sr)AlSiN₃:Eu²⁺. With the system (Ca, Sr, Ba)₂Si₅N₈:Eu²⁺ usually only dominant wavelengths of λ_{dom} >580 nm can be realized, with (Ca, Sr)AlSiN₃:E²⁺ even only λ_{dom>}587 nm. Even orange emitting Eu²⁺-activated α-SiAlONs usually only realize dominant wavelengths of λ_{dom>}580 nm. For the conversion of blue primary radiation of an LED into secondary radiation in the yellow spectral range, conversion-based LED solutions currently almost exclusively use Ce³⁺-activated Y₃Al₅O₁₂:Ce³⁺ (YAG). Other known luminophores with longer wavelengths include Tb₃Al₅O₁₂:Ce³⁺ (TbAG) or Gd₃Al₅O₁₂:Ce³⁺ (GdAG), but these are not suitable for the application as they exhibit strong thermal quenching.

In contrast to the various luminophores known to date, the luminophore described here can be used to realize a wide range of applications cheaply and efficiently:

If the composition of the luminophore is selected within the general formula EA₂₋ₓREₓSi_{5-x-y}Al_{x+y}N_{8-y}O_{y}:A such that the luminophore emits in the cyan-green spectral range, it can be used in human-centric lighting, for example, where an increased cyan component in the spectrum is desirable.

If the composition of the luminophore is selected within the general formula EA₂₋ₓREₓSi_{5-x-y}Al_{x+y}N_{8-y}O_{y}:A such that the luminophore emits in the yellow to orange spectral range, it can be used in a radiation-emitting component to generate warm-white light with only one, for example Ce³⁺-activated luminophore. The luminophore is also suitable for full conversion for orange applications, such as automotive flashing lights.

If the composition of the luminophore is selected within the general formula EA₂₋ₓREₓSi_{5-x-y}Al_{x+y}N_{8-y}O_{y}:A such that the luminophore emits in the red to NIR spectral range, it can be used for spectroscopic applications where, for example, the near-infrared window is important. It can also be used in IR-enhanced Human Centric Lighting applications in which the health-promoting effect of NIR radiation is utilized. Such a luminophore can also be used as a component for LEDs to treat eye conditions or support eye regeneration.

Because NIR/IR luminophores have only been used commercially for a very short time, luminophores that efficiently convert NUV to blue primary radiation into deep red to NIR secondary radiation, for example, have hardly been used to date. Therefore, the luminophore described here, which emits in particular broadband in the deep red to NIR spectral range, contributes to an efficient and thus favorable solution for such applications.

According to at least one embodiment, A is an element or a combination of elements selected from the group Ce and Eu. A can therefore be Ce³⁺ or Eu²⁺, for example.

Since most applications commonly used today operate at high irradiance levels, the luminophore described here, which is activated with Ce³⁺, can be used advantageously for such applications, as it is usually expected for it to have low quenching effects at high irradiance levels. This is mainly due to the low lifetime of the excited state for Ce³⁺. The typical lifetime of the excited state of a Ce³⁺ ion during conversion is usually less than 100 ns, while typical lifetimes for the excited state of, for example, Eu²⁺ are in the range of 1 μs to 10 μs. Thus, the luminophore described here can also be used at higher irradiance levels due to its low flux quenching, especially if Ce³⁺ is selected as the activator element.

On the other hand, activating the luminophore described here with Eu offers the possibility of shifting the emission spectrum into the red to NIR spectral range, for which there are currently no efficient and inexpensive solutions for the application.

A luminophore activated with Ce³⁺ described here can, for example, convert UV to blue primary radiation into secondary radiation in the cyan to orange spectral range. Depending on how the x in the general formula of the luminophore is chosen, EA₂₋ₓREₓSi_{5-x-y}Al_{x+y}N_{8-y}O_{y}:Ce can thus be a cyan-green or orange emitting luminophore and, in particular, replace previously used, less stable luminophores that emit in these spectral ranges.

A luminophore activated with Eu²⁺ as described here can, for example, convert UV to blue primary radiation into secondary radiation in the orange to NIR spectral range, in particular the red to NIR spectral range. Depending on how the x is chosen in the general formula of the luminophore, EA₂₋ₓREₓSi_{5-x-y}Al_{x+y}N_{8-y}O_{y}:Eu can thus be an orange to deep red luminophore with NIR component or an NIR luminophore. This means that the luminophore described here is also suitable for applications that require these spectral ranges, for example for the spectroscopy of biological samples.

According to at least one embodiment, the content of A in the luminophore is selected from the range including 0.01 mol % to including 10 mol %, in particular from the range including 0.1 mol % to including 5 mol %, with respect the content of EA and RE.

According to at least one embodiment, EA is an element or a combination of elements selected from the group Ba and Sr. EA can thus be either Ba, Sr or a combination of Ba and Sr.

According to at least one embodiment, EA is Ba, Sr or a combination of Ba and Sr and the activator element A is Ce. According to at least one further embodiment, EA is Ba or a combination of Ba and Sr and the activator element A is Eu.

According to at least one embodiment, RE is an element or a combination of elements selected from the group of lanthanides and Y. Lanthanides are understood here and in the following to mean the elements lanthanum, cerium, praseodymium, neodymium, promethium, samarium, europium, gadolinium, terbium, dysprosium, holmium, erbium, thulium, ytterbium and lutetium. In particular, RE is the element La.

According to at least one embodiment, x in the general formula of the luminophore is chosen such that 0<x<1.15, in particular 0<x<1, for example 0.2<x<1. The choice of x determines the content of RE, for example La, in the luminophore, which in turn can be used to influence the emission range of the luminophore. For example, a lower content of RE, in particular at x<0.5, for example 0.2<x <0.5, can lead to a shorter wavelength emission, while a higher content of RE, in particular at x>0.5, can lead to a longer wavelength emission.

According to at least one embodiment, it is 0.2<x≤2.

According to at least one embodiment, the luminophore has the molecular formula EA₂₋ₓREₓSi₅₋ₓAl_{x+y}N₈:A . In other words, y=0 in the general formula EA₂₋ₓREₓSi_{5-x-y}Al_{x+y}N_{8-y}O_{y}:A.

According to at least one embodiment, the luminophore has a formula selected from (Ba, Sr)₂₋ₓLaₓSi₅₋ₓAlₓN₈:Ce³⁺ and (Ba, Sr)₂₋ₓLaₓSi₅₋ₓAlₓN₈:Eu²⁺. (Ba, Sr)₂₋ₓLaₓSi₅₋ₓAlₓN₈:Ce³⁺ is a Ce³⁺-activated luminophore that converts UV to blue primary radiation into secondary radiation in the cyan to orange spectral range, depending on the x selected. (Ba, Sr)₂₋ₓLaₓSi₅₋ₓAlₓN₈:Ce³⁺ is therefore suitable as a cyan-green or orange luminophore, depending on the x, especially for use in LEDs. Compared to previously used Eu-doped luminophores, such a luminophore represents a solution that is more stable against quenching in these spectral ranges. Due to the increased cyan content of the emitted radiation compared to conventional luminophores and the excitability in the deep blue to NUV spectral range, such a luminophore can also be used well for Human Centric Lighting applications. With orange emission, on the other hand, the luminophore can be used to generate warm-white light in radiation-emitting components with only one Ce-activated luminophore or for orange-emitting components with full conversion by the luminophore.

(Ba, Sr)₂₋ₓLaₓSi₅₋ₓAlₓN₈:Eu²⁺ is a Eu-²⁺-activated luminophore that converts UV to blue primary radiation into radiation in the orange to NIR spectral range, in particular the red to NIR spectral range. (Ba, Sr)₂₋ₓLaₓSi₅₋ₓAlₓN₈:Eu²⁺ is thus suitable as an orange to deep red luminophore with NIR content for use in LEDs, for example in IR-enhanced LEDs, or as an NIR luminophore for use in NIR LEDs, for example for spectrometric applications.

According to at least one embodiment, the luminophore comprises a crystalline, for example ceramic, host lattice. In particular, the crystalline host lattice is composed of a generally periodically repeating three-dimensional unit cell. In other words, the unit cell is the smallest recurring unit of the crystalline host lattice. All contained elements occupy therein fixed positions, so-called point positions, of the three-dimensional unit cell of the host lattice.

Six lattice parameters are required to describe the three-dimensional unit cell of the crystalline host lattice: three lengths a, b and c and three angles α, β and γ. The three lattice parameters a, b and c are the lengths of the lattice vectors that span the unit cell. The other three lattice parameters α, β and γ are the angles between these lattice vectors. α is the angle between b and c, β is the angle between a and c and γ is the angle between a and b.

According to at least one embodiment, the luminophore comprises a unit cell having angles α, β and γ between lattice vectors, wherein the angles α, γ and γ are approximately or exactly 90°, respectively. According to at least one further embodiment, the unit cell has lattice vectors with a length a, b and c, wherein the lengths a, b and c are the same or different from each other. Conceivable ranges for the lengths are, for example,5.3 \acute{Å}<a<6.2 \acute{Å}, 6.5 \acute{Å}<b<7.4 \acute{Å} and 9.0 \acute{Å}<c<9.8 \acute{Å}.

According to at least one embodiment, the luminophore crystallizes in an orthorhombic space group. In particular, the luminophore crystallizes in the orthorhombic space group Pmn2₁ (Nr. 31).

The luminophore described here crystallizes in the structure of the known, rare-earth-free Ba₂Si₅N₈. Both EA and RE as well as Si and Al occupy the same crystallographic positions.

According to at least one embodiment, the luminophore has Si-centered Si(N,O)₄-tetrahedra and Al-centered Al(N,O)₄-tetrahedra, wherein the tetrahedra are corner-linked on all sides. Corner-linked on all sides means that each tetrahedron is linked to one corner of another tetrahedron via all four corners. The on all sides corner-linked tetrahedra form a tetrahedral network.

The Si(N,O)₄-tetrahedra or Al(N,O)₄-tetrahedra can each have a tetrahedral gap. The tetrahedral gap is a region in the interior of the respective tetrahedron. For example, the term “tetrahedral gap” refers to the region inside the tetrahedron that remains free when touching spheres are placed in the corners of the tetrahedron.

The N or O atoms of the Si(N,O)₄-tetrahedra or Al(N,O)₄-tetrahedra span the tetrahedron, wherein the Si or Al atom is located in the tetrahedral gap of the spanned tetrahedron. In other words, the tetrahedra are centered around the Si or Al atom. The Si or Al atom is surrounded by four N and/or O atoms in the shape of a tetrahedron. In particular, all atoms that span the tetrahedron have a similar distance to the Si or Al atom that is located in the tetrahedral gap.

According to at least one embodiment, the Si(N,O)₄-tetrahedra and Al(N,O)₄-tetrahedra form six-membered rings and four-membered rings, with gaps within the six-membered rings each being occupied by an EA or RE atom.

According to at least one embodiment, the luminophore has an absorption range at least in the UV to red wavelength range of the electromagnetic spectrum. In particular, the luminophore has an absorption range in the UV to blue wavelength range. For example, the luminophore has an absorption range in the wavelength range from 300 nm to 600 nm, in particular 350 nm to 500 nm, for example at 420 nm.

According to at least one embodiment, the luminophore emits in the cyan to orange and/or in the orange to near-infrared, in particular red to near-infrared, wavelength range of the electromagnetic spectrum. For example, if Ce is selected as the activator element, the luminophore emits in the cyan to orange wavelength range, while if Eu is selected as the activator element, the luminophore emits in the orange, in particular red, to NIR wavelength range.

According to at least one embodiment, an electromagnetic radiation emitted by the luminophore has a centeroid wavelength between 600 nm inclusive and 900 nm inclusive. For example, the electromagnetic radiation emitted by the luminophore has a centeroid wavelength between 650 nm inclusive and 850 nm inclusive, in particular between 670 nm inclusive and 830 nm inclusive. In particular, a luminophore described herein, in which Eu is selected as the activator element, has such a centeroid wavelength.

The centroid wavelength denotes a centroid of a spectral distribution of an emission spectrum. In other words, the centroid wavelength indicates where the center of the emission spectrum is located. The centroid wavelength is calculated as the weighted arithmetic mean of the wavelengths λ, weighted with their amplitudes using the distribution function s(λ):

$${λ}_{centroid} = \frac{{\int }_{- ∞}^{∞} λ \cdot s ( λ ) d λ}{{\int }_{- ∞}^{∞} s ( λ ) d λ} .$$

The luminophore may further have a dominant wavelength. According to at least one embodiment, an electromagnetic radiation emitted by the luminophore has a dominant wavelength between 450 nm inclusive and 620 nm inclusive, for example between 480 nm inclusive and 600 nm inclusive. In particular, a luminophore described herein, in which Ce is selected as the activator element, has such a dominant wavelength.

To determine the dominant wavelength of the electromagnetic radiation emitted by the luminophore, a straight line is drawn in the CIE standard diagram starting from the white point through the color position of the electromagnetic radiation. The intersection of the straight line with the spectral color line delimiting the CIE standard diagram denotes the dominant wavelength of the electromagnetic radiation. In general, the dominant wavelength differs from the wavelength of the emission maximum.

According to at least one embodiment, an electromagnetic radiation emitted by the luminophore has an emission maximum of at least one emission peak between 430 nm inclusive and 950 nm inclusive. The position of the emission peak with the emission maximum can be influenced in particular by the choice of activator element A and by the content of RE, i.e. the size of x. For example, the luminophore with EA=Ba and A=Ce and x<0.5 has an emission maximum in the range 430nm to 550 nm, the luminophore with A=Ce and x>0.5 has an emission maximum in the range 550 nm to 620 nm, the luminophore with EA=Sr and A=Ce and x<0.5 has a maximum emission in the range 510 nm to 630 nm, the luminophore with EA=Ba and A=Eu and x<0.3 has a maximum emission in the range 500 nm to 650 nm and the luminophore with A=Eu and x >0.3 has a maximum emission in the range 650 nm to 950 nm.

According to at least one embodiment, the electromagnetic radiation emitted by the luminophore has an emission maximum of at least one emission peak between 430 nm inclusive and 550 nm inclusive, between 550 nm inclusive and 620 nm inclusive, between 510 nm inclusive and 630 nm inclusive, between 500 nm inclusive and 650 nm inclusive, or between 650 nm inclusive and 950 nm inclusive.

According to at least one embodiment, an electromagnetic radiation emitted by the luminophore has a spectral half-width between 80 nm inclusive and 230 nm inclusive. The exact composition of the luminophore can influence the half-width.

This means that a large spectral range of emission can be covered by selecting a suitable composition for the luminophore, making it suitable for many different applications.

For example, a luminophore described here with A=Ce and x<0.5 can have an emission in the cyan spectral range. Such an emission has a large overlap with the sensitivity curve of the photoreceptor melanopsin in the human eye and thus a high melanopic ELR (ELR: “efficacy of luminous radiation”). The ability to excite the luminophore with UV and/or deep blue radiation makes it particularly flexible for use in such human-centric lighting applications.

The luminophore described here can also be used well as an orange-emitting luminophore, for example if EA=Ba, A=Ce and x>0.5. It can therefore be used in all applications in which a slight red component is required in addition to brightness, such as in lighting solutions for general lighting, automotive headlights or flashing lights. In such applications, the luminophore described here is characterized in particular by a higher color rendering index and an extended color temperature range compared to conventional luminophores. Furthermore, it has a higher stability than previously known orange-emitting luminophores.

For example, a luminophore described herein with A=Eu and x >0.3, in particular x>0.5, furthermore emits broadband in the deep red to NIR spectral range, in particular in the range 640 nm to 1040 nm. The radiation-emitting component can then be used as a light source for spectroscopic investigations in biological samples, as the broadband emission of the luminophore in the NIR range is well suited to provide radiation in the near-infrared window for biological tissue, i.e. radiation in the wavelength range from about 650 nm to 1350 nm. Such radiation can propagate as far as possible through biological tissue.

In addition, the luminophore described here can be used to exploit the fact that a NIR radiation component in radiation-emitting components can have a health-promoting effect. For example, NIR luminophores can be used in the range of 600 nm to 1000 nm in the treatment of eye conditions. The luminophore described here can also be used for this so-called “IR-enhanced human centric lighting” application range, as the spectral range required for this can be covered, in particular when A=Eu and x<0.5, in particular x<0.3. In particular, EA in this case is Ba or a combination of Ba and Sr.

A method for the production of a luminophore is further provided. In particular, the method can be used to produce a luminophore as described above. All features and embodiments disclosed in connection with the luminophore thus also apply to the method and vice versa.

According to at least one embodiment, with the method a luminophore is produced having the general formula EA₂₋ₓREₓSi_{5-x-y}Al_{x+y}N_{8-y}O_{y}:A where 0<x≤2 and 0≤y≤2, EA is an element or a combination of elements from the group of alkaline earth elements, RE is an element or a combination of elements from the group of rare earth elements, and A is an activator element. According to at least one embodiment, the method comprises the steps of providing reactants, mixing the reactants to form a reactant mixture, and heating the reactant mixture. During heating, the reactants are reacted and the luminophore is formed.

According to at least one embodiment, the reactants are selected from a group comprising oxides, nitrides, carbonates, nitrates, oxalates, citrates, each of EA, RE, Si, Al and A, and combinations thereof. For example, at least one of Sro, Sr₃N₂, Sr₂N, Bao, SrAl₂O₄, Sr₃Al₂N₄, LaN, BaN_{y} (with y approximately equal to 0.7 to 1), AlN, Si₃N₄, CeO₂ and Eu₂O₃ are selected as reactants.

According to at least one embodiment, the mixing of the reactants takes place in a protective gas atmosphere. For example, the reactants are mixed in a glovebox. After mixing, the resulting mixture of reactants can be transferred to a crucible, for example a tungsten crucible.

According to at least one embodiment, the reactant mixture is heated to a temperature in the range between 1400° C. inclusive and 2100° C. inclusive, in particular between 1500° C. inclusive and 2000° C. inclusive, for example between 1600° C. inclusive and 1950° C. inclusive.

According to at least one embodiment, the reactant mixture is heated for a period of from 0.5 h up to and including 24 h.

According to at least one embodiment, the reactant mixture is heated in an N₂ atmosphere or a forming gas atmosphere. According to one embodiment, the forming gas atmosphere is composed of N₂ and H₂, for example with a ratio of 95/5 (N₂/H₂).

According to at least one embodiment, no overpressure or an overpressure is applied during heating. According to at least one embodiment, the heating is carried out at normal pressure or a pressure selected from the range between 3 bar inclusive and 100 bar inclusive, in particular between 5 bar inclusive and 50 bar inclusive, for example between 10 bar inclusive and 30 bar inclusive.

A radiation emitting component is further provided. According to at least one embodiment, the radiation-emitting component comprises a semiconductor chip which, in operation, emits electromagnetic radiation of a first wavelength range, and a conversion element which has at least one luminophore described herein which converts electromagnetic radiation of the first wavelength range into electromagnetic radiation of a second wavelength range which is at least partially different from the first wavelength range.

The luminophore described above is particularly suitable and intended for use in a radiation-emitting component. Features and embodiments described in connection with the luminophore and/or the method for the production of a luminophore thus also apply to the radiation-emitting component and vice versa.

The electromagnetic radiation of the first wavelength range forms the emission spectrum of the semiconductor chip and is also referred to as primary radiation.

The semiconductor chip is, for example, a light-emitting diode chip or a laser diode chip. The component can therefore be a light-emitting diode (LED) or a laser. In at least one case, the semiconductor chip has an epitaxially grown semiconductor layer sequence with an active zone that is suitable for generating electromagnetic radiation. For example, the active zone has therefore a pn junction, a double heterostructure, a single quantum well structure or a multiple quantum well structure.

During operation, the semiconductor chip can emit electromagnetic radiation, for example from the ultraviolet spectral range and/or from the visible spectral range, in particular from the blue spectral range. The primary radiation thus has wavelengths in the range from 300 nm to 600 nm, for example.

The conversion element is arranged in particular on the semiconductor chip, for example on a radiation exit surface of the semiconductor chip. In particular, the conversion element is located in the beam path of the semiconductor chip, so that at least some of the radiation emitted by the semiconductor chip strikes the conversion element.

The at least one luminophore in the conversion element converts electromagnetic radiation of the first wavelength range into electromagnetic radiation of a second wavelength range. The electromagnetic radiation of the second wavelength range forms the emission spectrum of the luminophore and is also referred to as secondary radiation.

The electromagnetic radiation of the second wavelength range is at least partially different from the first wavelength range. The luminophore contained in the conversion element or of which the conversion element consists imparts wavelength-converting properties to the conversion element. For example, the conversion element only partially converts the electromagnetic radiation of the semiconductor chip into electromagnetic radiation of the second wavelength range, while a further part of the electromagnetic radiation of the semiconductor chip is transmitted by the conversion element. In this case, the radiation-emitting component emits mixed light, which is composed of electromagnetic radiation of the first wavelength range and electromagnetic radiation of the second wavelength range. The mixed light includes, for example, white light. If the primary radiation is completely converted by the conversion element and/or there is no transmission of primary radiation by the conversion element, this is referred to as full conversion. In this case, the radiation-emitting component emits the secondary radiation emitted by the conversion element.

According to at least one embodiment, the conversion element comprises a second luminophore as described above, which converts electromagnetic radiation of the first wavelength range into electromagnetic radiation of a third wavelength range which is at least partially different from the first and second wavelength range. In the conversion element thus at least two different luminophores as described herein are combined, which form a mixture of luminophores. Different emission colors can be combined in this luminophore mixture. Since the luminophores belong to the same luminophore system and thus have the same host lattice, such a combination can be easily realized. This makes it possible to provide a luminophore mixture with an adapted chromaticity coordinate depending on the application, which can be further processed into conversion ceramics.

Alternatively or additionally, according to a further embodiment, the conversion element has a further luminophore which converts electromagnetic radiation of the first wavelength range into electromagnetic radiation of a fourth wavelength range which is at least partially different from the first, second and optionally third wavelength range. The further luminophore may be selected from luminophores which are different from the luminophore described herein.

According to at least one embodiment, the first luminophore and the second luminophore have at least different x and/or different A. This allows a first and a second luminophore to be selected whose emission is different from one another.

Due to the nature of the first and possibly second luminophore described herein, the radiation-emitting component has advantages over conventional components. In particular, the component can be used for many different applications, depending on which composition of the luminophore or luminophores is selected in the conversion element. For example, an application in the human centric lighting sector, in general lighting, in the spectroscopy of biological samples and in IR enhanced human centric lighting is conceivable if the luminophore or substances are suitably selected and used as described above.

According to at least one embodiment, the conversion element is designed as a conversion layer. The conversion layer can be applied to the semiconductor chip in direct or indirect contact. In the case of indirect contact, it can be applied to the radiation exit surface by means of an adhesive layer, for example, or a potting can be applied between the radiation exit surface and the conversion element.

According to a further embodiment, the semiconductor chip, optionally the conversion layer and optionally an adhesive layer can be surrounded by a potting. For example, the semiconductor chip, conversion element and, optionally, an adhesive layer are then arranged in the recess of a housing, in which the potting is further arranged. A potting can have a transmittance for the primary radiation and/or the secondary radiation and/or the radiation emitted by other luminophores present, which is at least 85%, including, for example, at least 95%. Furthermore, a potting can be made of silicone or epoxy resin, for example.

According to at least one embodiment, the first and optionally the second luminophore is present in the conversion element as a ceramic. In such a case, the conversion layer may consist of the luminophore or optionally the luminophores forming the ceramic. Alternatively, particles of the first and optionally second luminophore may be present embedded in a matrix, for example a polymer matrix.

### BRIEF DESCRIPTION OF THE DRAWINGS

Further advantageous embodiments, configurations and further developments of the luminophore, the method for the production of a luminophore and the radiation-emitting component arise from the following exemplary embodiments in conjunction with the illustrated figures.

FIG. 1 shows a schematic sectional view of a radiation-emitting component according to an exemplary embodiment.

FIG. 2 shows a schematic sectional view of a radiation-emitting component according to an exemplary embodiment.

FIG. 3 shows emission spectra of the luminophore according to exemplary embodiments.

FIG. 4 shows emission spectra of crystals of luminophores according to exemplary embodiments.

FIG. 5 shows emission spectra of the luminophore according to exemplary embodiment.

FIG. 6 shows an emission spectrum of the luminophore according to an exemplary embodiment.

FIG. 7 shows emission spectra of the luminophore according to an exemplary embodiment and according to comparative examples in comparison to the sensitivity curve of the photoreceptor melanopsin.

FIG. 8 shows emission spectra of comparative examples.

FIG. 9 shows a simulated emission spectrum of a component according to an exemplary embodiment.

FIG. 10 shows a simulated emission spectrum of a component according to a comparative example.

FIG. 11 shows a simulated emission spectrum of a component according to a comparative example.

FIG. 12 shows emission spectra of a luminophore according to an exemplary embodiment and according to a comparative example.

FIG. 13 shows reflectance spectra of luminophores according to exemplary embodiments.

### DETAILED DESCRIPTION

Elements that are identical, similar or have the same effect are marked with the same reference symbols in the figures. The figures and the proportions of the elements shown in the figures should not be considered to be to scale. Rather, individual elements, in particular layer thicknesses, may be shown in exaggerated size for better visualization and/or understanding.

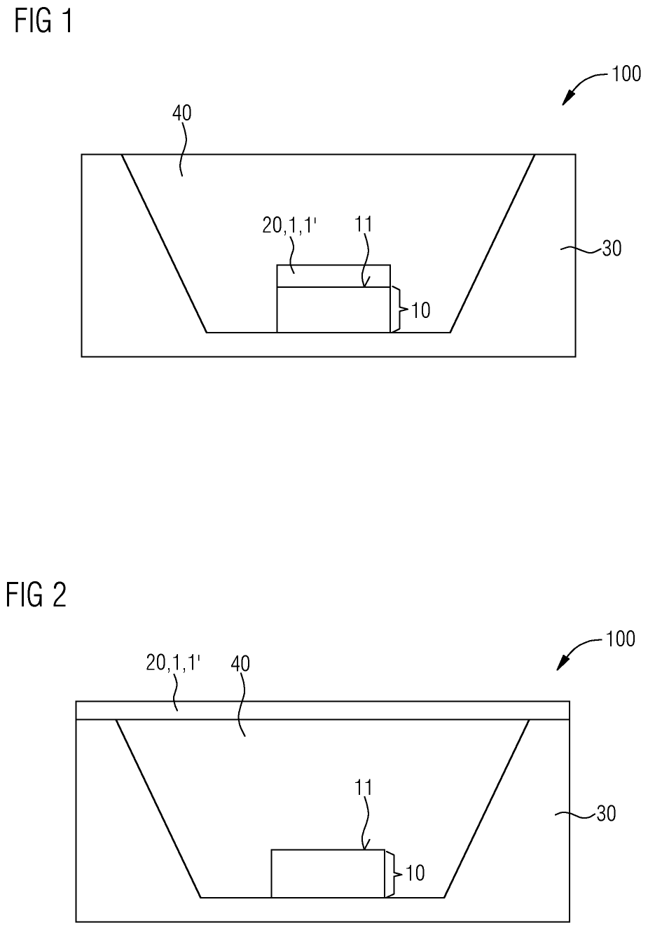

FIG. 1 shows a schematic sectional view of a radiation-emitting component according to an exemplary embodiment. The radiation-emitting component 100 has a semiconductor chip 10. During operation, the semiconductor chip 10 emits electromagnetic radiation of a first wavelength range (primary radiation) from a radiation exit surface 11. The semiconductor chip 10 has an epitaxially grown semiconductor layer sequence with an active zone that is suitable for generating electromagnetic radiation. The primary radiation has, for example, wavelengths in the blue to red range, in particular in the blue and/or ultraviolet range.

Furthermore, the component has a conversion element 20. The conversion element 20 either contains a matrix in which the first luminophore 1, in particular particles of the first luminophore 1, is embedded, or the conversion element 20 has or consists of a ceramic formed from the luminophore 1. Alternatively, the conversion element 20 contains a matrix in which a luminophore mixture containing particles of the first luminophore 1 and a second luminophore 1′ are embedded, or the conversion element 20 has or consists of a ceramic formed from the luminophore mixture containing the first luminophore 1 and the second luminophore 1′. In addition or alternatively, a further, for example conventional, luminophore may also be present in the conversion element 20 and form a luminophore mixture with the luminophore 1 and, if appropriate, luminophore 1′.

If the conversion element 20 has a matrix in which the first luminophore 1 and possibly the second luminophore 1′ and/or possibly other luminophores are embedded, the matrix has a material selected from polymers such as polystyrene, polysiloxane, polysilazane, PMMA, polycarbonate, polyacrylate, polytetrafluoroethylene, polyvinyl, silicone resin, silicone, epoxy resin and transparent synthetic rubber, and glass such as silicates, water glass and quartz glass.

The conversion element 20, which is designed here as a conversion layer, can either be applied directly to the semiconductor chip 10, in particular to the radiation exit surface 11, or can be attached to it, for example by means of an adhesive layer (not explicitly shown here).

The semiconductor chip 10 with the conversion element 20 arranged thereon is arranged in the recess of a housing 30. The housing 30 has side surfaces that are beveled towards the semiconductor chip 10 and can be reflective. In this exemplary embodiment, the semiconductor chip 10 and the conversion element 20 are surrounded by a potting 40 in the housing 30. However, the presence of a potting 40 is not absolutely necessary. The potting can be formed from a silicone or epoxy resin, for example, and has a transmittance for electromagnetic radiation of the active zone 12 that is at least 85%, and in at least some instances, at least 95%.

Alternatively, the housing 30 can also have no side walls and thus no recess and be designed as a carrier (not shown here). FIG. 2 shows another exemplary embodiment of a radiation-emitting component. The explanations made with reference to FIG. 1 apply to the elements with the same reference signs. In this exemplary embodiment, the conversion element 20 is not arranged directly on the semiconductor chip 10, but spaced from it on the side of the potting 40 facing away from the semiconductor chip 10. Here too, the conversion element 20 is again formed as a conversion layer.

The components shown in FIGS. 1 and 2 are LEDs, for example. For the sake of clarity, additional elements, such as electrical contacts, are not shown in FIGS. 1 and 2.

The exemplary embodiment mentioned below apply equally to the first luminophore 1 and the second luminophore 1′. For the sake of simplicity, only the luminophore 1 is referred to below.

During operation of the radiation-emitting component 100, the luminophore 1 converts electromagnetic radiation of the first wavelength range into electromagnetic radiation of the second wavelength range (secondary radiation). If several different luminophores are present, the total secondary radiation is composed of the respective wavelength ranges emitted by the luminophores.

In the following, the preparation of exemplary embodiments of the luminophore 1 of the general formula EA₂₋ₓREₓSi_{5-x-y}Al_{x+y}N_{8-y}O_{y}:A where EA=Ba, RE=La and A is either Eu or Ce is explained.

The reactants LaN, BaN_{y} with y approximately equal to 0.7 to 1, Si₃N₄, AlN and, depending on the selected activator element A, CeO₂ or Eu₂O₃ are provided, intimately mixed in a glovebox under an inert gas atmosphere and then transferred to a tungsten crucible. The synthesis of the luminophore 1 takes place during heating at temperatures between 1400° C. and 2100° C., including, for example, between 1500° C. and 2000° C., or between 1600° C. and 1950° C., for a period of 0.5 h to 24 h under N₂ or forming gas. In addition, an overpressure of 3 bar to 100 bar, for example, 5 bar to 50 bar, or for example, 10 bar to 30 bar can be used. It is also possible to carry out the process without overpressure.

Tables 1 and 2 show the weights for exemplary embodiments 1 to 11. Exemplary embodiments 1 to 7 have the formula Ba₂₋ₓLaₓSi₅₋ₓAlₓN₈:Ce³⁺ with variable x (Table 1), exemplary embodiments 8 to 11 have the formula Ba₂₋ₓLaₓSi₅₋ₓAlₓN₈:Eu²⁺ with variable x (Table 2). The x was calculated in each case from the weighed ratio of La and Ba. The x-values given in Tables 1 and 2 therefore correspond to the nominal weights.

TABLE 1

| | x | LaN | | AlN | | BaN_{y} | | Si₃N₄ | | CeO₂ | |
|---|---|---|---|---|---|---|---|---|---|---|---|
| Exemplary | 0.16 | 0.426 | g | 0.112 | g | 5.025 | g | 4.402 | g | 0.035 | g |
| embodiment 1 | | | | | | | | | | | |
| Exemplary | 0.36 | 0.957 | g | 0.251 | g | 4.236 | g | 4.517 | g | 0.040 | g |
| embodiment 2 | | | | | | | | | | | |
| Exemplary | 0.66 | 1.638 | g | 0.430 | g | 3.223 | g | 4.664 | g | 0.045 | g |
| embodiment 3 | | | | | | | | | | | |
| Exemplary | 1.14 | 2.543 | g | 0.668 | g | 1.877 | g | 4.860 | g | 0.053 | g |
| embodiment 4 | | | | | | | | | | | |
| Exemplary | 1 | 0.5833 | g | 0.4691 | g | 0.5709 | g | 0.3568 | g | 0.02 | g |
| embodiment 5 | | | | | | | | | | | |
| Exemplary | 1 | 0.8187 | g | 0.1097 | g | 0.8012 | g | 0.2504 | g | 0.02 | g |
| embodiment 6 | | | | | | | | | | | |
| Exemplary | 1 | 0.5704 | g | 0.1530 | g | 0.5585 | g | 0.6980 | g | 0.02 | g |
| embodiment 7 | | | | | | | | | | | |

TABLE 2

| | x | LaN | AlN | BaN_{y} | | Si₃N₄ | Eu₂O₃ |
|---|---|---|---|---|---|---|---|
| Exemplary | 0.16 | 1.067 g | 0.281 g | 12.431 | g | 11.040 g | 0.181 g |
| embodiment 8 | | | | | | | |
| Exemplary | 0.36 | 2.396 g | 0.629 g | 10.461 | g | 11.311 g | 0.203 g |
| embodiment 9 | | | | | | | |
| Exemplary | 0.66 | 4.093 g | 1.076 g | 7.944 | g | 11.657 g | 0.231 g |
| embodiment 10 | | | | | | | |
| Exemplary | 1.14 | 6.339 g | 1.666 g | 4.614 | g | 12.114 g | 0.268 g |
| embodiment 11 | | | | | | | |

The phases Ba₂₋ₓLaₓSi₅₋ₓAlₓN₈:Ce³⁺ and Ba₂₋ₓLaₓSi₅₋ₓAlₓN₈:Eu²⁺ were found mixed with other phases in the specified exemplary embodiments. The exact composition of the crystals results from the ratio of Ba to La, which was determined by means of energy dispersive X-ray spectroscopy (EDX) analysis, and the charge neutrality, which is achieved by an adjusted ratio of Si to Al. This results, for example, in a composition of Ba_{1,86}La_{0,14}Si_{4,86}Al_{0,14}N₈ for the crystal from exemplary embodiment 2 and a composition of Ba_{1,13}La_{0,87}Si_{4,13}Al_{0,87}N₈ for the crystal from exemplary embodiment 7. For two crystals of exemplary embodiment 5, x=0.37 and 0.56 could be determined.

In the following, the preparation of the luminophore 1 according to exemplary embodiment 12 with the general formula EA₂₋ₓREₓSi_{5-x-y}Al_{x+y}N_{8-y}O_{y}:A where EA=Sr, RE=La and A=Ce is explained.

The reactants LaN, Sr₃N₂, Si₃N₄, AlN and CeO₂ are provided, intimately mixed in a glovebox under an inert gas atmosphere and then transferred to a tungsten crucible. The synthesis of the luminophore according to exemplary embodiment 12 takes place during heating at temperatures between 1400° C. and 2100° C., for example, between 1500° C. and 2000° C., or for example, between 1600° C. and 1950° C., for a period of 0.5 h to 24 h under N₂ or forming gas. In addition, an overpressure of 3 bar to 100 bar, for example, 5 bar to 50 bar, or for example, 10 bar to 30 bar can be used.

For example, crystals with the composition according to exemplary embodiment 12 were formed from a reactant mixture of 4.171 g Sr₃N₂, 10.161 g Si₃N₄, 0.594 g AlN and 0.075 g CeO₂, the lanthanum content found in EDX measurements originates from contaminants of the crucible used with LaN from previous syntheses.

The phase Sr₂₋ₓLaₓSi₅₋ₓAlₓN₈:Ce³⁺ was found mixed with other phases in the given exemplary embodiment. The exact composition of the crystals results from the ratio Sr to La, which was determined by means of energy dispersive X-ray spectroscopy (EDX) analysis, as well as the charge neutrality, which is achieved by an adapted ratio Si to Al. This results, for example, in a composition of Sr_{1,7}La_{0,3}Si_{4,7}Al_{0,3}N₈ for the crystal from exemplary embodiment 12.

For all exemplary embodiments, the phase Ba₂₋ₓLaₓSi₅₋ₓAlₓN₈ or Sr₂₋ₓLaₓSi₅₋ₓAlₓN₈ was clearly detected in the corresponding samples by single crystal diffractometry. Table 3 shows the lattice parameters, the crystallographic data and the basic quality parameters of Ba₂₋ₓLaₓSi₅₋ₓAlₓN₈:Ce³⁺, which were determined by X-ray diffraction on crystals of exemplary embodiment 2 and exemplary embodiment 7.

TABLE 3

| | Single crystal | | Single crystal | |
|---|---|---|---|---|
| | from exemplary | | from exemplary | |
| | embodiment 2 | | embodiment 7 | |
| Molecular formula | (Ba,La)₂(Si,Al)₅N₈ | | (Ba,La)₂(Si,Al)₅N₈ | |
| Crystal system | Orthorhombic | | Orthorhombic | |
| Room group | Pmn2₁ (No. 31) | | Pmn2₁ (No. 31) | |
| a/Å | 5.7854 | (4) | 5.8064 | (3) |
| b/Å | 6.9432 | (5) | 6.8550 | (4) |
| c/Å | 9.4016 | (7) | 9.4932 | (5) |
| Cell volume/Å³ | 377.65 | (5) | 377.86 | (4) |
| T/K | 296 | (2) | 296 | (2) |

| | | |
|---|---|---|
| Radiation | Cu—Kα (λ = 1.542 | Cu—Kα (λ = 1.542 |
| | Å) | Å) |
| Measuring range | 6.4 < ϑ < 71.7 | 6.5 < ϑ < 66.7 |
| | −7 ≤ h ≤ 6 | −6 ≤ h ≤ 6 |
| | −8 ≤ k ≤ 8 | −8 ≤ k ≤ 7 |
| | −9 ≤ l ≤ 11 | −10 ≤ l ≤9 |
| Number of all reflexes | 6422 | 2007 |
| Independent reflexes | 786 | 642 |
| Number of parameters | 83 | 46 |
| Δρₘₐₓ, Δρₘᵢₙ/eÅ⁻³ | 2.355/−1.766 | 1.882/−2.387 |
| R₁ (obs/all) | 0.0709/0.1076 | 0.0683/0.1015 |
| wR₂ (obs/all) | 0.1725/0.1974 | 0.1415/0.1627 |
| GooF | 0.991 | 1.120 |

The crystallographic position parameters of exemplary embodiment 7 are summarized in Table 4. The Wyckoff position describes the symmetry of the point positions according to R. W. G. Wyckoff. x, y and z indicate the atomic positions. Uₐₙᵢ is the radius of the anisotropic deflection parameters of the respective atom. Uᵢₛₒ is the radius of the isotropic deflection parameters of the respective atom.

TABLE 4

| | Atom | Wyckoff | | | | | Uᵢₛₒ |
|---|---|---|---|---|---|---|---|
| Name | type | location | x | y | z | Occupation | *Uₐₙᵢ |
| Ba01 | Ba | 2a | 0 | 0.8821(5) | 0.0000(4) | 0.5 | 0.0308(13)* |
| La01 | La | 2a | 0 | 0.8821(5) | 0.0000(4) | 0.5 | 0.0308(13)* |
| Ba02 | Ba | 2a | 0 | 0.8544(5) | 0.6303(3) | 0.5 | 0.0269(12)* |
| La02 | La | 2a | 0 | 0.8544(5) | 0.6303(3) | 0.5 | 0.0269(12)* |
| Si01 | Si | 4b | 0.2507(14) | 0.6637(11) | 0.3078(14) | 1 | 0.0092(19) |
| Si02 | Si | 2a | 0 | 0.0550(15) | 0.304(2) | 1 | 0.008(3) |
| Si03 | Si | 2a | 0 | 0.403(2) | 0.5288(16) | 1 | 0.011(3) |
| Si04 | Si | 2a | 0 | 0.424(2) | 0.0857(16) | 1 | 0.010(3) |
| N001 | N | 2a | 0 | 0.175(6) | 0.464(5) | 1 | 0.018(12) |
| N002 | N | 4b | 0.237(5) | 0.914(4) | 0.295(4) | 1 | 0.020(7) |
| N003 | N | 4b | 0.247(5) | 0.445(4) | 0.635(3) | 1 | 0.017(7) |
| N004 | N | 2a | 0 | 0.578(5) | 0.399(4) | 1 | 0.008(9) |
| N005 | N | 2a | 0 | 0.186(7) | 0.151(6) | 1 | 0.023(11) |
| N006 | N | 2a | 0 | 0.426(5) | 0.907(4) | 1 | 0.008(9) |

It can thus be shown that the luminophore 1 crystallizes in the structure of the rare earth-free, known Ba₂Si₅N₈.

Both Ba and La as well as Si and Al occupy the same crystallographic positions. Due to the comparable electron density, these elements cannot be differentiated using X-ray methods; in the refinement, the occupation was either fixed or only Ba or Si was refined.

The luminophore 1 with the formula Ba₂₋ₓLaₓSi₅₋ₓAlₓN₈:Ce³⁺ crystallizes in the orthorhombic space group Pmn2₁ (No. 31). Its structure is a three-dimensionally linked network of on all sides corner-linked SiN₄-tetrahedra. These SiN₄- and AlN₄-tetrahedra form six-membered rings and four-membered rings; the Ba and La atoms occupy gaps within the six-membered rings.

The spectral properties of exemplary embodiments 1 to 7 are given in Tables 5 and 6:

TABLE 5

| | Exemplary | Exemplary | Exemplary | Exemplary |
|---|---|---|---|---|
| | embodiment 1 | embodiment 2 | embodiment 3 | embodiment 4 |
| Dominant wavelength | 488 nm | Not calculable | 578 nm | 581 nm |
| λ_{dom} | | (center color | | |
| | | triangle) | | |
| Peak wavelength λₘₐₓ | 471 nm | 490 nm | 588 nm | 597 nm |
| FWHM | 106 nm | 161 nm | 178 nm | 172 nm |
| CIE-x | 0.215 | 0.290 | 0.434 | 0.485 |
| CIE-y | 0.296 | 0.371 | 0.435 | 0.451 |

The data shown in Table 5 were obtained with an excitation at 408 nm. For exemplary embodiment 2, the dominant wavelength cannot be calculated because the chromaticity coordinate of the luminophore is too central in the CIE color triangle, so that it is not possible to extrapolate clearly to the edge.

TABLE 6

| | Exemplary | Exemplary | Exemplary | Exemplary |
|---|---|---|---|---|
| | embodiment 2, | embodiment 5, | embodiment 5, | embodiment 7, |
| | crystal 1 | crystal 1 | crystal 2 | crystal 1 |
| x (determined by EDX) | 0.14 | 0.37 | 0.56 | 0.87 |
| Excitation | 408 nm | 408 nm | 448 nm | 448 nm |
| wavelength λₑₓ | | | | |
| Dominance | 486 nm | Not calculable | 577 nm | 583 nm |
| wavelength λ_{dom} | | (center color | | |
| | | triangle) | | |
| Peak | 465 nm | 493 nm | 585 nm | 602 nm |
| wavelength λₘₐₓ | | | | |
| FWHM | 103 nm | 176 nm | 158 nm | 162 nm |
| CIE-x | 0.203 | 0.304 | 0.475 | 0.525 |
| CIE-y | 0.277 | 0.384 | 0.484 | 0.462 |

Table 6 shows the spectral data of four crystals of exemplary embodiments 2, 5 and 7. For exemplary embodiment 5, crystal 1, the dominant wavelength cannot be calculated because the chromaticity coordinate of the luminophore is too central in the CIE color triangle, so that it is not possible to extrapolate clearly to the edge.

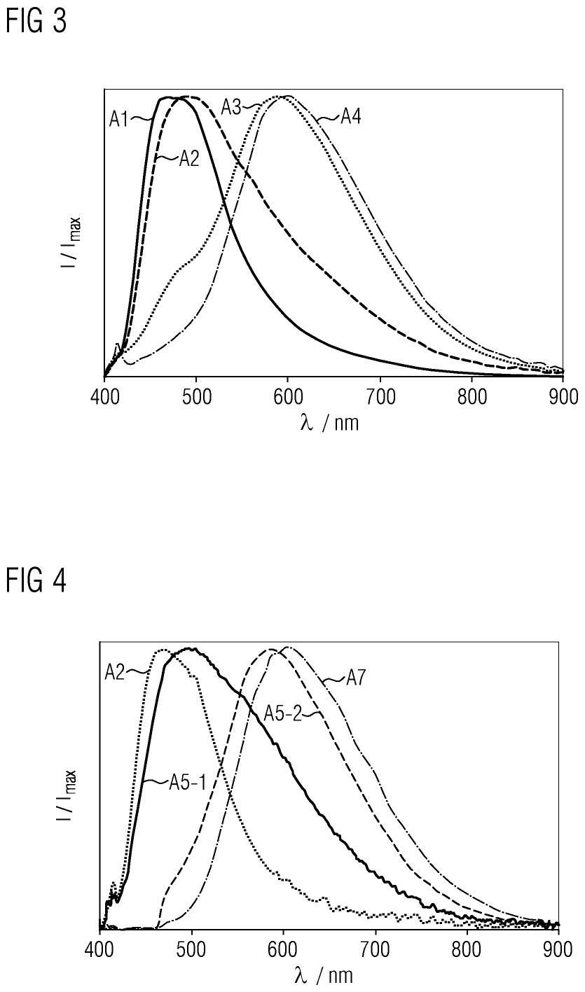

FIGS. 3 and 4 show the corresponding emission spectra. In each case, the wavelength λ in nm is plotted against the relative intensity I/Iₘₐₓ. In these and the following figures, the spectra of the respective exemplary embodiments are labeled with the number of the exemplary embodiment preceded by A. FIG. 3 shows the emission spectra of exemplary embodiments 1 to 4 when excited at 408 nm (Al: solid line, nominal x=0.16, A2: dashed line, nominal x=0.36, A3: dotted line, nominal x=0.66, A4: dash-dot line, nominal x=1.14). FIG. 4 shows emission spectra of one crystal of exemplary embodiment 2 (excitation 408 nm, A2, dotted line, x =0.14 confirmed by EDX), two crystals of exemplary embodiment 5 (A5-1: Crystal 1, excitation 408 nm, solid line, X=0.37 confirmed by EDX, A5-2: Crystal 2, excitation 448 nm, dashed line, x=0.56 confirmed by EDX) and one crystal of exemplary embodiment 7 (A7, excitation 448 nm, dash-dot line, x=0.87 confirmed by EDX).

The luminophore 1 with A=Ce according to exemplary embodiments 1 to 7 thus converts, depending on x, UV to blue primary radiation into secondary radiation in the cyan to orange spectral range. Depending on x, the dominant wavelength is between 486 nm (crystal from exemplary embodiment 2) and 583 nm (crystal from exemplary embodiment 7). The emission band has a spectral half-width FWHM of 103 nm to 178 nm. This makes Ba₂₋ₓLaₓSi₅₋ₓAlₓN₈:Ce³⁺ suitable for use in LEDs as a cyan-green or orange conversion luminophore, depending on x.

Table 7 shows the spectral data of exemplary embodiments 8 to 11, which were obtained with excitation at 448 nm.

TABLE 7

| | Exemplary | Exemplary | Exemplary | Exemplary |
|---|---|---|---|---|
| | embodiment 8 | embodiment 9 | embodiment 10 | embodiment 11 |
| Centroid wavelength_{λcentroid} | 679 nm | 789 nm | 822 nm | 828 nm |
| Peak wavelength λₘₐₓ | 584 nm | 805 nm | 801 nm | 804 nm |
| FWHM | 90 nm | 210 nm | 206 nm | 208 nm |

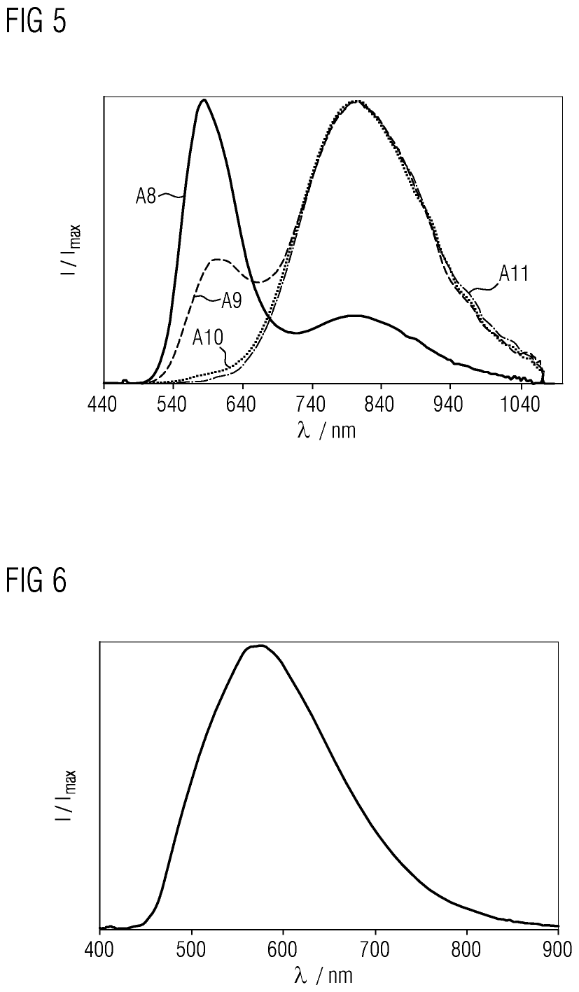

The corresponding emission spectra are shown in FIG. 5. Exemplary embodiment 8 is shown with the solid line (A8, nominal x=0.16), exemplary embodiment 9 with the dashed line (A9, nominal x=0.36), exemplary embodiment 10 with the dotted line (A10, nominal x=0.66) and exemplary embodiment 11 with the dash-dot line (A11, nominal x=1.14).

The luminophore 1 with A=Eu according to exemplary embodiments 8 to 11 converts UV to blue primary radiation into secondary radiation in the red to NIR spectral range. It emits with a centroid wavelength of λ_{centroid} from 679 nm to 828 nm. The emission band has a spectral half-width FWHM of 90 nm to 210 nm. This makes Ba₂₋ₓLaₓSi₅₋ₓAlₓN₈:Eu²⁺ suitable, depending on x, as a deep red conversion luminophore with NIR content for use in LEDs, e.g. in IR-enhanced LEDs, or as an NIR luminophore for use in NIR LEDs, e.g. for spectrometric applications.

Table 8 shows the spectral data of exemplary embodiment 12, which were obtained with excitation at 408 nm.

TABLE 8

| | Exemplary embodiment |
|---|---|
| | 12, crystal 1 |
| x (determined by EDX) | 0.3 |
| Excitation wavelength λₑₓ | 408 nm |
| Dominant wavelength λ_{dom} | 573 nm |
| Peak wavelength λₘₐₓ | 574 nm |
| FWHM | 173 nm |
| CIE-x | 0.439 |
| CIE-y | 0.494 |

The corresponding emission spectrum is shown in FIG. 6.

The luminophore 1 with A=Ce and EA=Sr according to the exemplary embodiment 12 converts UV to blue primary radiation into secondary radiation in the orange spectral range. It emits with a dominant wavelength of λ_{dom} Of 573 nm. The emission band has a spectral half-width FWHM of 173 nm. This makes Sr₂₋ₓLaₓSi₅₋ₓAlₓN₈:Eu²⁺ suitable as an orange conversion luminophore for use in LEDs.

In the following, various properties and applications of the luminophore 1 are described with reference to the exemplary embodiments in comparison to the comparative examples 1(Ba₂Si₅N₈:Ce³⁺), 2 (Y₃(Al, Ga)₅O₁₂: Ce³⁺, YAGaG), 3 (Lu₃Al₅O₁₂:Ce³⁺, LuAG), 4 (Y₃Al₅O₁₂:Ce³⁺, YAG:Ce³⁺) and 5 (Ba₂Si₅N₈:Eu²⁺). The spectra of the comparative examples shown in the figures are preceded by a V.

Comparative examples 2 and 4 are luminophores that crystallize in the garnet structure in the cubic space group Ia3̅d. YAG absorbs radiation in the blue spectral range and emits in the yellow spectral range. The exact emission position can be influenced somewhat by replacing Al with Ga. The exact spectral values for YAG and YAGaG depend on the degree of doping, grain size and the exact composition (Ga content). Typical spectral values for YAG are between 565 nm and 574 nm for the dominant wavelength and between 110 nm and 125 nm for the spectral half-width. LuAG absorbs radiation in the blue spectral range and emits in the green spectral range. Typical spectral values for LuAG are between 558 nm to 562 nm for the dominant wavelength and between 106 nm to 120 nm for the spectral half-width.

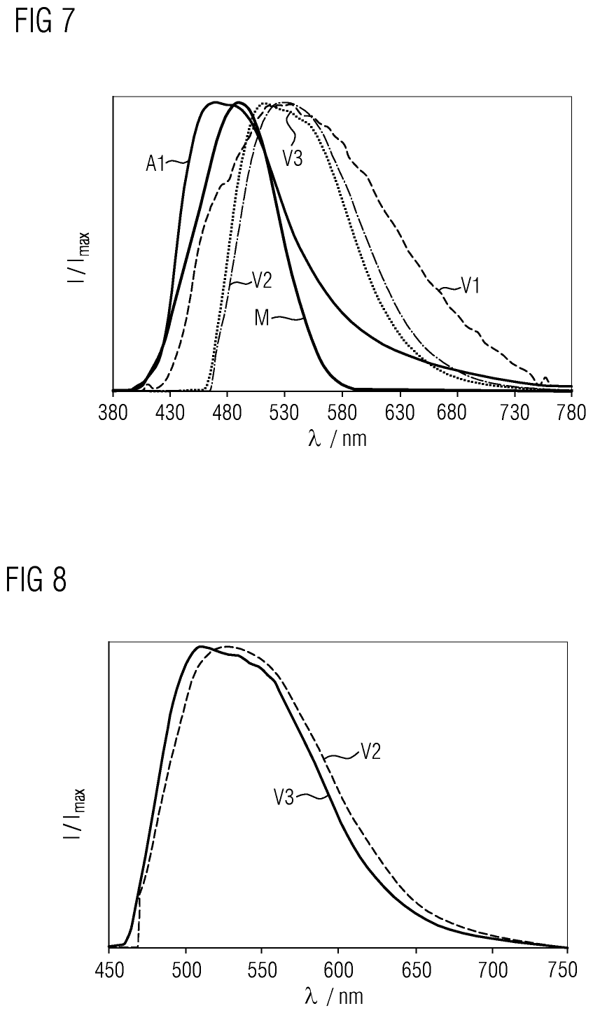

FIG. 7 shows the overlap of the emission spectra of exemplary embodiment 1 (A1, solid, thin line), comparative example 1 (V1, dashed line), comparative example 2 (V2, dot-dash line) and comparative example 3 (V3, dotted line) with the sensitivity curve of the photoreceptor melanopsin (M, solid, thick line). FIG. 8 again shows the emission spectra of comparative examples 2 (V2, dashed line) and 3 (V3, solid line) at an excitation of 460 nm.

Exemplary embodiment 1, Ba₂₋ₓLaₓSi₅₋ₓAlₓN₈:Ce³⁺ with x<0.5, emits in a narrow band in the cyan spectral range. The emission is significantly narrower than that of comparative example 1, resulting in a greater overlap with the sensitivity curve of the photoreceptor melanopsin and thus a higher “melanopic efficacy of luminous radiation” (“melanopic ELR”). The overlap is even smaller for the comparative examples 2 and 3.

Table 9 shows the achieved values of the melanopic ELR (relative to daylight) for exemplary embodiment 1 and the comparative examples 1 to 3:

TABLE 9

| | Comparative | Comparative | Comparative | Exemplary |
|---|---|---|---|---|
| | example 1 | example 2 | example 3 | embodiment 1 |
| Luminophore | (Ba₂Si₅N₈:Ce³⁺) | (YAGaG:Ce³⁺) | (LuAG:Ce³⁺) | (Ba₂₋ₓLaₓSi₅₋ₓAlₓN₈:Ce³⁺) |
| melanopic ELR | 0.7914 | 0.6236 | 0.7325 | 1.6625 |
| relative | 100% | 79% | 93% | 210% |
| melanopic ELR | | | | |

Comparative example 1 is surpassed by exemplary embodiment 1 by 110%, the difference compared to comparative examples 2 and 3 is even greater. In addition, the luminophores of comparative examples 2 and 3 cannot be excited in the NUV and deep blue spectral range, in contrast to luminophore 1, such as here, for example, in exemplary embodiment 1, which makes them less flexible for use in human-centric lighting applications.

Exemplary embodiment 4, Ba₂₋ₓLaₓSi₅₋ₓAlₓN₈:Ce³⁺ with x>0.5, emits broadband in the orange spectral range. This makes it an efficient Ce³⁺-based luminophore that emits in the orange spectral range (λ_{dom}>575 nm). Luminophore 1 can therefore be advantageous for all applications in which a slight red component is required in addition to brightness (e.g. lighting solutions for general lighting, automotive headlights or flashing lights).

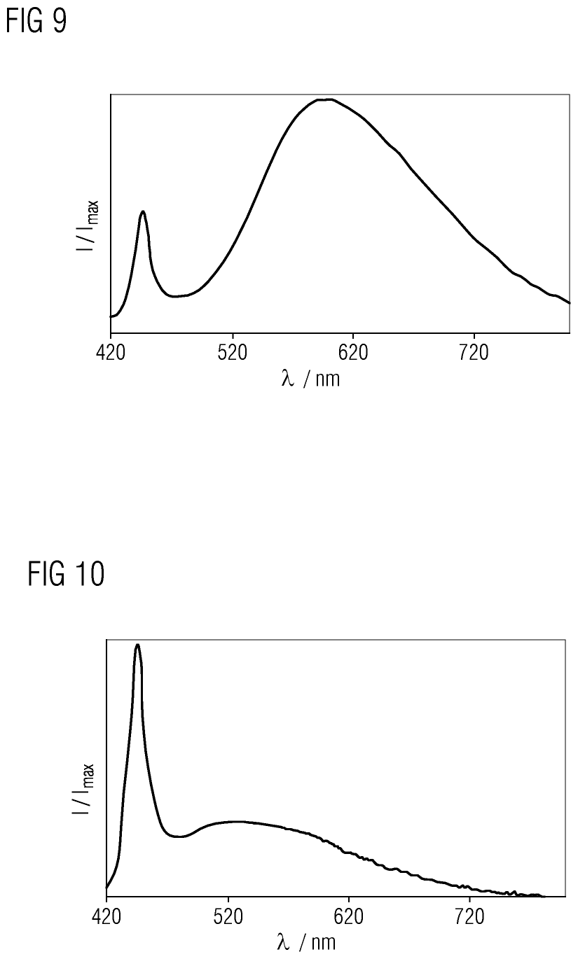

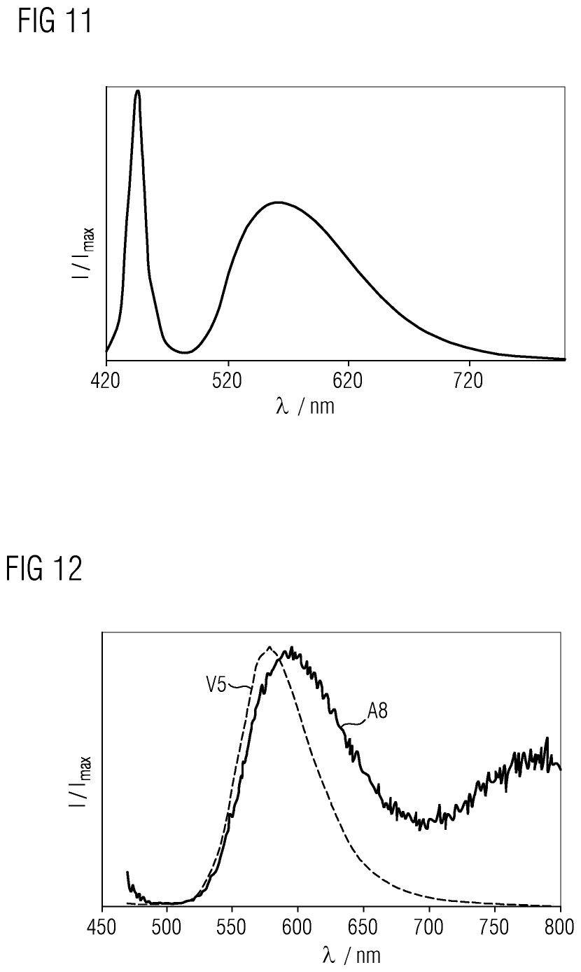

As an example of such an application, FIGS. 9 to 11 show simulated spectra and Table 10 shows the associated spectral data for white light LEDs consisting of a blue LED and the luminophore 1 according to exemplary embodiment 4 (FIG. 9), the La-free Ba₂Si₅N₈:Ce³⁺ (comparative example 1, FIG. 10) or a commercially available luminophore (comparative example 4, YAG:Ce, FIG. 11):

TABLE 10

| | Comparative | Comparative | Exemplary |
|---|---|---|---|
| | example 1 | example 4 | embodiment 4 |
| Luminophore | (Ba₂Si₅N₈:Ce³⁺) | (YAG:Ce³⁺) | (Ba₂₋ₓLaₓSi₅₋ₓAlₓN₈:Ce³⁺) |
| Color temperature CCT | 10888 K | 4369 K | 2788 K |
| Color rendering CRI | 89 | 63 | 77 |

The solution with the luminophore 1 according to exemplary embodiment 4 achieves a higher color rendering index CRI=77 compared to CRI=63 for the solution with comparative example 4. Comparative example 4 is one of the longest wavelength Ce³⁺-activated luminophores in use today. As the achievable color temperature depends directly on the emission position, the color temperature of 4369 K simulated here is one of the lowest color temperatures that can be achieved with conventional Ce³⁺-activated luminophores. Color temperatures below 4000 K (CCT<4000 K) are usually not achievable with these luminophores. The simulated solution with luminophore 1 (exemplary embodiment 4), on the other hand, achieves a color temperature of 2788 K. This means that luminophore 1 considerably extends the range in which Ce³⁺-activated luminophores can be used compared to the solutions available today.

Comparative example 1, on the other hand, achieves a very high CRI of 89 however with a very high color temperature of 10888 K and is therefore not suitable for use as a single luminophore for a white light solution.

The luminophore 1 with the formula Ba₂₋ₓLaₓSi₅₋ₓAlₓN₈:Eu²⁺ emits broadband in the deep red to NIR (IR-A) spectral range, in which not many known luminophores emit. The broadband emission of luminophore 1 in the near infrared range is well suited to provide radiation in the near-infrared window for biological tissue. This lies in the wavelength range from approx. 650 nm to 1350 nm and refers to the wavelength range in which light can propagate as far as possible through biological tissue. Light sources that provide broadband light in this spectral range are therefore advantageous for spectroscopic investigations in biological samples. The luminophore 1 is well suited for this purpose, as it provides a lot of broadband radiation between approx. 640 nm and 1040 nm (see FIG. 5), especially at high x (for example, exemplary embodiment 11).

Furthermore, NIR radiation in illuminating devices can have a health-promoting effect. For example, NIR luminophores in the 600 nm to 1000 nm range can be used advantageously in the treatment of eye diseases. The luminophore 1 is therefore also suitable for these new “IR-enhanced human centric lighting” applications, as this range can be covered with the luminophore 1. The version with low x, in particular x<0.5, (for example exemplary embodiment 8), which provides both a red component for generating white light and an NIR component, is particularly suitable for this purpose. In contrast, comparative example 5, Ba₂Si₅N₈:Eu²⁺ without La, only provides emission in the orange spectral range. For an “IR-enhanced human centric lighting” application, using this comparative example would therefore require an additional NIR luminophore, which would increase the complexity of the overall system. The comparison of the emission spectra of exemplary embodiment 8 (A8) and comparative example 5 (V5) is shown in FIG. 12.

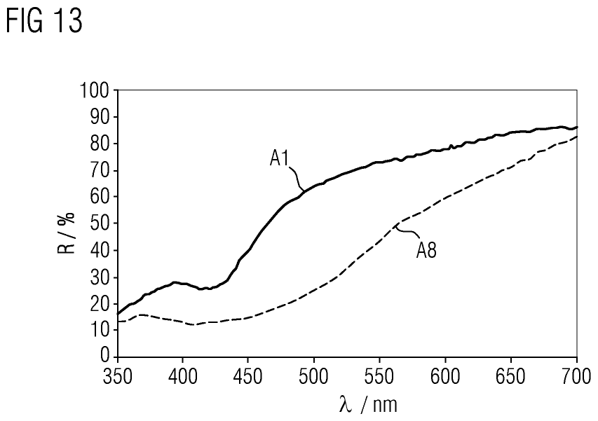

FIG. 13 shows the reflectance spectra of exemplary embodiments 1 (A1) and 8 (A8). The wavelength λ in nm is plotted against the reflectance R in %. It can be seen that the luminophore 1 according to exemplary embodiment 1 can be excited up to a wavelength of about 450 nm, according to exemplary embodiment 8 up to a wavelength of about 550 nm.

The features and exemplary embodiments described in connection with the figures can be combined with one another according to further exemplary embodiments, even if not all combinations are explicitly described. Furthermore, the exemplary embodiments described in connection with the figures may alternatively or additionally have further features as described in the general part.

The present disclosure is not limited to the description based on the exemplary embodiments. Rather, the present disclosure includes any new feature as well as any combination of features, which includes in particular any combination of features in the patent claims, even if this feature or combination itself is not explicitly stated in the patent claims or exemplary embodiments.

### List of Reference Symbols

1 Luminophore
1′ Second luminophore
10 Semiconductor chip
11 Radiation exit surface
20 Conversion element
30 Housing
40 Potting
100 Radiation-emitting component
λ Wavelength
I/Iₘₐₓ Relative intensity
R Reflectance
A1 Spectrum of exemplary embodiment 1
A2 Spectrum of exemplary embodiment 2
A3 Spectrum of exemplary embodiment 3
A4 Spectrum of exemplary embodiment 4
A5-1 Spectrum of exemplary embodiment 5, crystal 1
A5-2 Spectrum of exemplary embodiment 5, crystal 2
A7 Spectrum of exemplary embodiment 7
A8 Spectrum of exemplary embodiment 8
A9 Spectrum of exemplary embodiment 9
A10 Spectrum of exemplary embodiment 10
A11 Spectrum of exemplary embodiment 11
V1 Spectrum of the comparative example 1
V2 Spectrum of the comparative example 2
V3 Spectrum of the comparative example 3
V4 Spectrum of the comparative example 4
V5 Spectrum of the comparative example 5

1. A luminophore with the general formula
EA₂₋ₓREₓSi_{5-x-y}Al_{x+y}N_{8-y}O_{y}:A
wherein
$$0.2 < x \leq 2 and 0 \leq y \leq 2 ,$$
EA is an element or a combination of elements from the group Ba and Sr,
RE is an element or a combination of elements from the group formed by scandium, yttrium, lanthanum, cerium, praseodymium, neodymium, promethium, samarium, europium, terbium, dysprosium, holmium, erbium, thulium, ytterbium and lutetium, and
A is an activator element.

2. The luminophore with the general formula
EA₂₋ₓREₓSi_{5-x-y}Al_{x+y}N_{8-y}O_{y}:A
wherein
$$0 < x \leq 2 and 0 \leq y \leq 2 ,$$
EA is an element or a combination of elements from a group of alkaline earth elements,
RE is an element or a combination of elements from a group formed by scandium, lanthanum, cerium, praseodymium, neodymium, promethium, samarium, europium, terbium, dysprosium, holmium, erbium, thulium, ytterbium and lutetium,
A is an activator element, and
an electromagnetic radiation emitted by the luminophore has an emission maximum of at least one emission peak between 550 nm inclusive and 620 nm inclusive.

3. The luminophore according to claim 1, wherein A is an element or a combination of elements selected from the group Ce and Eu.

4. (canceled)

5. The luminophore according to claim 1, wherein the luminophore has a formula selected from (Ba,Sr)₂₋ₓLaₓSi₅₋ₓAlₓN₈:Ce³⁺ and (Ba, Sr)₂₋ₓLaₓSi₅₋ₓAlₓN₈:Eu²⁺.

6. The luminophore according to claim 1, wherein the luminophore crystallizes in an orthorhombic space group.

7. The luminophore according to claim 1, wherein the luminophore comprises Si-centered Si(N,O)₄-tetrahedra and Al-centered Al(N,O)₄-tetrahedra, wherein the tetrahedra are corner-linked on all sides.

8. The luminophore according to claim 1, wherein the luminophore has an absorption range at least in the UV to red wavelength range of the electromagnetic spectrum.

9. The luminophore according to claim 1, wherein the luminophore emits in the cyan to orange and/or in the orange to near-infrared wavelength range of the electromagnetic spectrum.

10. The luminophore according to claim 1, wherein an electromagnetic radiation emitted by the luminophore has a centroid wavelength between 600 nm inclusive and 900 nm inclusive.

11. The luminophore according to claim 1, wherein an electromagnetic radiation emitted from the luminophore has a dominant wavelength between 450 nm inclusive and 620 nm inclusive.

12. The luminophore according to claim 1, wherein an electromagnetic radiation emitted by the luminophore has an emission maximum of at least one emission peak between 430 nm inclusive and 950 nm inclusive.

13. The luminophore according to claim 1, wherein an electromagnetic radiation emitted by the luminophore has a spectral half-width between 80 nm inclusive and 230 nm inclusive.

14. A method for the production of a luminophore having the general formula
EA₂₋ₓREₓSi_{5-x-y}Al_{x+y}N_{8-y}O_{y}:A
wherein
$$0.2 < x \leq 2 and 0 \leq y \leq 2 ,$$
EA is an element or a combination of elements from the group Ba and Sr,
RE is an element or a combination of elements from the group formed by scandium, yttrium, lanthanum, cerium, praseodymium, neodymium, promethium, samarium, europium, terbium, dysprosium, holmium, erbium, thulium, ytterbium and lutetium, and
A is an activator element,
wherein the method comprises:
providing reactants,
mixing the reactants to form a reactant mixture, and
heating the reactant mixture.

15. The method according to the claim 14, wherein the reactant mixture is heated to a temperature from the range between 1400° C. inclusive and 2100° C. inclusive and/or
wherein the reactant mixture is heated for a period of 0.5 hours inclusive up to and including 24 hours.

16. The method according to 14, wherein the reactant mixture is heated under N₂ atmosphere or forming gas atmosphere.

17. The method according to claim 14, wherein the heating is carried out at normal pressure or a pressure selected from the range between 3 bar inclusive up to and including 100 bar.

18. A radiation emitting component comprising:
a semiconductor chip which emits electromagnetic radiation of a first wavelength range during operation,
a conversion element comprising at least a first luminophore according to claim 1, which converts electromagnetic radiation of the first wavelength range into electromagnetic radiation of a second wavelength range which is at least partially different from the first wavelength range.

19. The radiation-emitting component according to claim 18, wherein the conversion element comprises a second luminophore, wherein the second lumiphore with the general formula
EA_{2-x′}RE_{x′}Si_{5-x′-y′}Al_{x′+y′}N_{8-y′}O′_{y}:A′
wherein
$$0.2 < {x}^{′} \leq 2 and 0 \leq {y}^{′} \leq 2 ,$$
EA is an element or a combination of elements from the group Ba and Sr.
RE is an element or a combination of elements from the group formed by scandium, yttrium, lanthanum, cerium, praseodymium, neodymium, promethium, samarium, europium, terbium, dysprosium, holmium, erbium, thulium, ytterbium and lutetium, and
A′ is an activator element,
wherein the second lumiphore is configured to convert electromagnetic radiation of the first wavelength range into electromagnetic radiation of a third wavelength range which is at least partially different from the first and second wavelength range.

20. The radiation-emitting component according to claim 19, wherein x and A of the first luminophore are respectively different from x′ and A′ and of the second luminophore.
